(19) United States
(12) Patent Application Publication
(10) Pub. No.: US 2016/0341046 A1
(43) Pub. Date: Nov. 24, 2016

(54) DUST HOLES

(71) Applicant: General Electric Company, Schenectady, NY (US)

(72) Inventors: KEVIN ROBERT FELDMANN, CINCINNATI, OH (US); ROBERT SCOTT BUNKER, CINCINNATI, OH (US); ROBERT DAVID BRIGGS, WEST CHESTER, OH (US); JASON RANDOLPH ALLEN, CINCINNATI, OH (US)

(21) Appl. No.: 14/718,120

(22) Filed: May 21, 2015

(51) Int. Cl. F01D 5/18

(52) U.S. Cl. CPC F01D 5/186; F05D 2260/202

(57) ABSTRACT

A turbine engine device comprising a turbine engine blade including a cooling channel extending on the interior of the blade, the cooling channel having at least one turn of greater than forty-five degrees, the cooling channel turn demarcated by a cooling channel wall having a curvature operative to redirect fluid flowing therein, the cooling channel wall including a dust opening leading into a dust hole demarcated by a dust wall having a longitudinal axis that is coaxial with a tangent line taken along the curvature of the cooling channel wall.

### CROSS-REFERENCE TO RELATED APPLICATION

This application claims priority to U.S. Provisional Application Ser. No. 62/004,717, filed May 29, 2014, the disclosure of which is incorporated herein by reference.

### BACKGROUND

The technology described herein relates generally to heat transfer in gas turbine engines and more particularly to apparatus for cooling structures in such engines.

A gas turbine engine includes a turbomachinery core having a high pressure compressor, combustor, and high pressure turbine (“HPT”) in serial flow relationship. The core is operable in a known manner to generate a primary gas flow. The high pressure turbine includes annular arrays (“rows”) of stationary vanes or nozzles that direct the gases exiting the combustor into rotating blades or buckets. Collectively one row of nozzles and one row of blades make up a “stage”. Typically two or more stages are used in serial flow relationship. The combustor and HPT components operate in an extremely high temperature environment, and must be cooled by air flow to ensure adequate service life.

Cooling air flow is typically provided by utilizing relatively lower-temperature “bleed” air extracted from an upstream part of the engine, for example the high pressure compressor, and then feeding that bleed air to high-temperature downstream components. The bleed air may be applied in numerous ways, for example through internal convection cooling or through film cooling. When used for convection cooling, the bleed air is often routed through serpentine passages or other structures that generate a pressure loss as the cooling air passes through them. Because bleed air represents a loss to the engine cycle and reduces efficiency, it is desired to maximize heat transfer rates and thereby use the minimum amount of cooling flow possible. And holes are provided through certain surfaces to allow particulates entrained within the airstream to pass through the HPT component.

One problem with the use of conventional dust holes is that flow stagnation zones occur around or proximate to the holes, thereby allowing particulates to deposit on the internal surfaces of the HPT component without exiting via the dust hole. Deposition of particulates on the internal surfaces of HPT components creates an insulating layer that decreases the heat transfer rate between the cooling airflow and the HPT component and can also operate to clog dust holes leading to even more particulate deposition.

An example of a particular gas turbine engine structure requiring effective cooling is an HPT blade. HPT blades are distributed as an array of airfoils extending from a central hub that are operative to rotate a shaft mounted to the hub as hot exhaust gases flow past the blades. Some prior art HPT blades have experienced temperatures above the design intent as a result of particulate buildup and reduced cooling effectiveness. In particular, particulate deposition as a layer between one and ten mils (one mil is equal to 1/1000 of an inch) thick on the front side of a HPT cooled surface has the potential to reduce back side cooling effectiveness by as much as 30-80%, depending on the circumstances.

Accordingly, there remains a need for improved dust holes and ancillary structures utilized to inhibit or greatly reduce the propensity of particulates entrained in airflow from becoming deposited upon cooling surfaces of HPT devices, such as HPT blades.

### BRIEF DESCRIPTION

A turbine engine device comprising a turbine engine blade including a cooling channel extending on the interior of the blade, the cooling channel having at least one turn of greater than forty-five degrees, the cooling channel turn demarcated by a cooling channel wall having a curvature operative to redirect fluid flowing therein, the cooling channel wall including a dust opening leading into a dust hole demarcated by a dust wall having a longitudinal axis that is coaxial with a tangent line taken along the curvature of the cooling channel wall.

### BRIEF DESCRIPTION OF THE DRAWINGS

The disclosure may be best understood by reference to the following description taken in conjunction with the accompanying drawing figures in which:

FIG. 1 is a partial cut-away view of an exemplary HPT blade through which cooling circuits are distributed.

FIG. 2 is a cross-sectional view of the HPT blade along line 2 in FIG. 1 showing a portion of the cooling circuits traversing the blade.

FIG. 3 is a magnified, cross-sectional view of the HPT blade of FIG. 2 taken at the tip showing prior art dust holes oriented perpendicular to the cooling circuit wall.

FIG. 4 is a graphical depiction of a portion of a U-turn cooling circuit within a HPT blade, where a series of tangent lines are shown representative of the angle of the interior cooling circuit wall at that location, which are progressively angled thirty degrees with respect to one another to show a change in ninety degrees midway through the U-turn.

FIG. 5 is a magnified, cross-sectional view of an exemplary HPT blade, taken at the tip, depicting incorporation of a first set of angled dust holes.

FIG. 6 is an even further magnified view of FIG. 5 showing the first set of angled dust holes.

FIG. 7 is a magnified, cross-sectional view of a further exemplary HPT blade, taken at the tip, depicting incorporation of a second and third angled dust holes.

FIG. 8 is a magnified, cross-sectional view of a further exemplary HPT blade, taken at the tip, depicting incorporation of a fourth series of angled dust holes.

FIG. 9 is an elevated perspective view of a series of different deflectors that may be used pursuant to the instant disclosure with one or more of the exemplary dust holes described herein.

FIG. 10 is a magnified, cross-sectional view of a further exemplary HPT blade, taken at the tip, depicting incorporation of the exemplary deflectors with the angled dust holes.

### DETAILED DESCRIPTION

The exemplary embodiments of the present disclosure are described and illustrated below to encompass methods and devices for removing particulates from bulk airflow and, more specifically, to methods and devices that may be used to remove particulates entrained within a cooling fluid while flowing within a jet engine. Of course, it will be apparent to those of ordinary skill in the art that the embodiments discussed below are exemplary in nature and may be reconfigured without departing from the scope and spirit of the present disclosure. However, for clarity and precision, the exemplary embodiments as discussed below may include optional steps, methods, and features that one of ordinary skill should recognize as not being a requisite to fall within the scope of the present disclosure.

It is a first aspect of the present disclosure to provide a turbine engine device comprising a turbine engine blade including a cooling channel extending on the interior of the blade, the cooling channel having at least one turn of greater than forty-five degrees, the cooling channel turn demarcated by a cooling channel wall having a curvature operative to redirect fluid flowing therein, the cooling channel wall including a dust opening leading into a dust hole demarcated by a dust wall having a longitudinal axis that is coaxial with a tangent line taken along the curvature of the cooling channel wall.

In a more detailed embodiment of the first aspect, the at least one turn is ninety degrees or greater. In yet another more detailed embodiment, the at least one turn is more than one hundred twenty degrees. In a further detailed embodiment, the cooling channel wall defining the at least one turn has an arcuate profile. In still a further detailed embodiment, the cooling channel wall defining the at least one turn comprises a plurality of planar surfaces in series that are each angled less than forty-five degrees with respect to an adjoining planar surface of the plurality of planar surfaces. In a more detailed embodiment, the turbine engine device includes a projection having a deflecting surface spaced from the cooling channel wall and configured to direct at least a portion of the fluid through the dust hole, where an angle of the deflecting surface is less than forty degrees different from the longitudinal axis of the dust wall. In a more detailed embodiment, the dust opening is positioned at least one of just prior to, within, and immediately following the at least one turn.

It is a second aspect of the present disclosure to provide a turbine engine device comprising a turbine engine blade including a cooling channel extending on the interior of the blade, the cooling channel having at least one turn of greater than forty-five degrees, the cooling channel turn demarcated by a cooling channel wall having a curvature operative to redirect fluid flowing therein, the cooling channel wall including a dust hole demarcated by a dust hole wall having a hole curvature that extends the curvature of the cooling channel wall.

In a more detailed embodiment of the second aspect, the at least one turn is ninety degrees or greater. In yet another more detailed embodiment, the at least one turn is more than one hundred twenty degrees. In a further detailed embodiment, the cooling channel wall defining the at least one turn has an arcuate profile. In still a further detailed embodiment, the cooling channel wall defining the at least one turn comprises a plurality of planar surfaces in series that are each angled less than forty-five degrees with respect to an adjoining planar surface of the plurality of planar surfaces. In a more detailed embodiment, the turbine engine device includes a projection having a deflecting surface spaced from the cooling channel wall and configured to direct at least a portion of the fluid through the dust hole, where an angle of the deflecting surface is less than forty degrees different from a longitudinal axis of the dust conduit wall. In a more detailed embodiment, the dust hole is positioned at least one of just prior to, within, and immediately following the at least one turn.

It is a third aspect of the present disclosure to provide a turbine engine device comprising a turbine engine blade including a cooling channel extending on the interior of the blade, the cooling channel having at least one turn configured to change a mean radial direction of fluid flowing therein by greater than forty-five degrees, the cooling channel turn demarcated by a cooling channel wall configured to change the mean radial direction of fluid flowing therein, the cooling channel wall including a dust passage oriented less than thirty degrees offset from the surrounding cooling channel wall, the cooling channel wall also including a deflector extending into the cooling channel upstream from the dust passage.

In yet another more detailed embodiment of the third aspect, the at least one turn is ninety degrees or greater. In yet another more detailed embodiment, the at least one turn is more than one hundred twenty degrees. In a further detailed embodiment, the cooling channel wall defining the at least one turn has an arcuate profile. In still a further detailed embodiment, the cooling channel wall defining the at least one turn comprises a plurality of planar surfaces in series that are each angled less than forty-five degrees with respect to an adjoining planar surface of the plurality of planar surfaces. In a more detailed embodiment, the turbine engine device includes a projection having a deflecting surface spaced from the cooling channel wall and configured to direct at least a portion of the fluid through the dust passage, where an angle of the deflecting surface is less than twenty degrees different from an angle of the dust passage wall. In a more detailed embodiment, the dust passage is oriented less than fifteen degrees offset from the surrounding cooling channel wall.

It is a fourth aspect of the present disclosure to provide a turbine engine device comprising a turbine engine blade including a cooling channel extending on the interior of the blade, the cooling channel having at least one turn of greater than forty-five degrees, the cooling channel turn demarcated by a cooling channel wall having a shape operative to redirect fluid flowing therein, the cooling channel wall including a dust hole within the cooling channel turn, the dust hole demarcated by a dust wall angled less than thirty degrees with respect to the cooling channel wall bordering the dust hole.

In a more detailed embodiment of the fourth aspect, the at least one turn is ninety degrees or greater. In yet another more detailed embodiment, the at least one turn is more than one hundred twenty degrees. In a further detailed embodiment, the cooling channel wall defining the at least one turn has an arcuate profile. In still a further detailed embodiment, the cooling channel wall defining the at least one turn comprises a plurality of planar surfaces in series that are each angled less than forty-five degrees with respect to an adjoining planar surface of the plurality of planar surfaces. In a more detailed embodiment, the turbine engine device includes a projection having a deflecting surface spaced from the cooling channel wall and configured to direct at least a portion of the fluid through the dust hole, where an angle of the deflecting surface is less than twenty degrees different from an angle of a dust conduit downstream from the dust hole.

It is a fifth aspect of the present disclosure to provide a turbine engine device comprising a turbine engine blade including a cooling channel extending on the interior of the blade, the cooling channel demarcated by a cooling channel wall establishing a mean radial direction of fluid flowing therein, the cooling channel also including a projection having a deflecting surface extending into the cooling channel and configured to change the mean radial direction of the fluid flowing therepast, the cooling channel wall including a dust hole proximate the projection, where the deflecting surface is configured to direct at least a portion of the fluid into the dust hole.

In a more detailed embodiment of the fifth aspect, the cooling channel wall demarcates at least one turn of greater than forty-five degrees. In yet another more detailed embodiment, the at least one turn is ninety degrees or greater. In a further detailed embodiment, the at least one turn is more than one hundred twenty degrees. In still a further detailed embodiment, the cooling channel wall defining the at least one turn has an arcuate profile, and an angle of the deflecting surface is less than twenty degrees different from an angle of a wall of the dust conduit. In a more detailed embodiment, the cooling channel wall defining the at least one turn comprises a plurality of planar surfaces in series that are each angled less than forty-five degrees with respect to an adjoining planar surface of the plurality of planar surfaces. In a more detailed embodiment, the projection is positioned at least one of just prior to, within, and immediately following the at least one turn. In another more detailed embodiment, the projection includes a fastback.

It is a sixth aspect of the present disclosure to provide a turbine engine device comprising a turbine engine blade including a cooling channel extending on the interior of the blade, the cooling channel having at least one turn of greater than forty-five degrees and operative to redirect fluid flowing therein, the cooling channel wall including a dust hole positioned at least one of just prior to, within, and immediately following the turn, where a mean radial direction of the dust hole is angled no more than forty-five degrees with respect to a mean radial direction of the cooling channel wall prior to reaching the dust hole.

In yet another more detailed embodiment of the sixth aspect, the at least one turn is ninety degrees or greater. In yet another more detailed embodiment, the at least one turn is more than one hundred twenty degrees. In a further detailed embodiment, the cooling channel wall defining the at least one turn has an arcuate profile. In still a further detailed embodiment, the cooling channel wall defining the at least one turn comprises a plurality of planar surfaces in series that are each angled less than forty-five degrees with respect to an adjoining planar surface of the plurality of planar surfaces. In a more detailed embodiment, the turbine engine device includes a projection having a deflecting surface spaced from the cooling channel wall and configured to direct at least a portion of the fluid through the dust hole, where an angle of the deflecting surface is less than forty degrees different from a radial axis extending along a dust conduit wall, which extends from the dust hole.

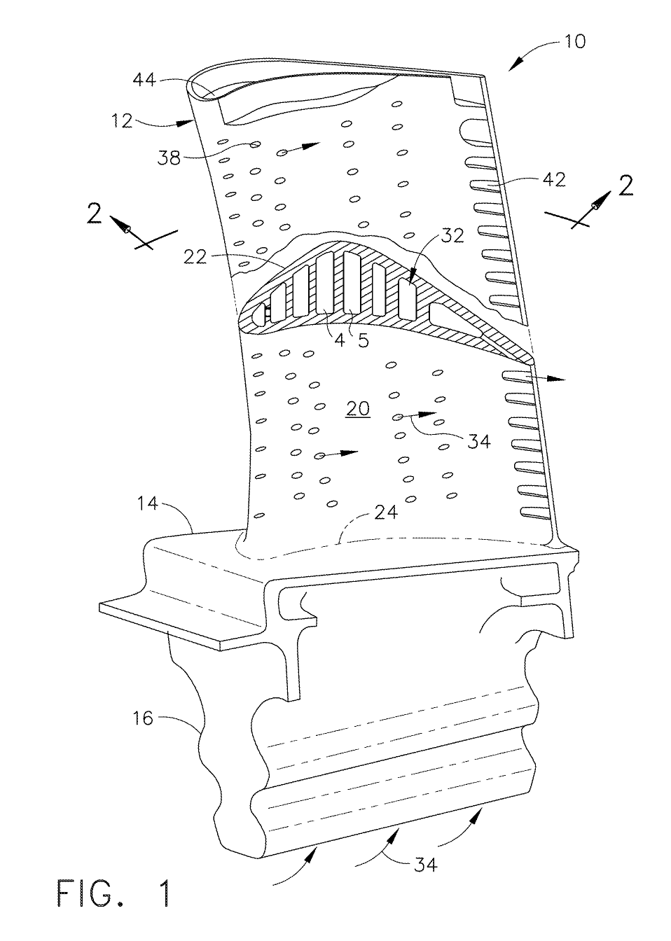

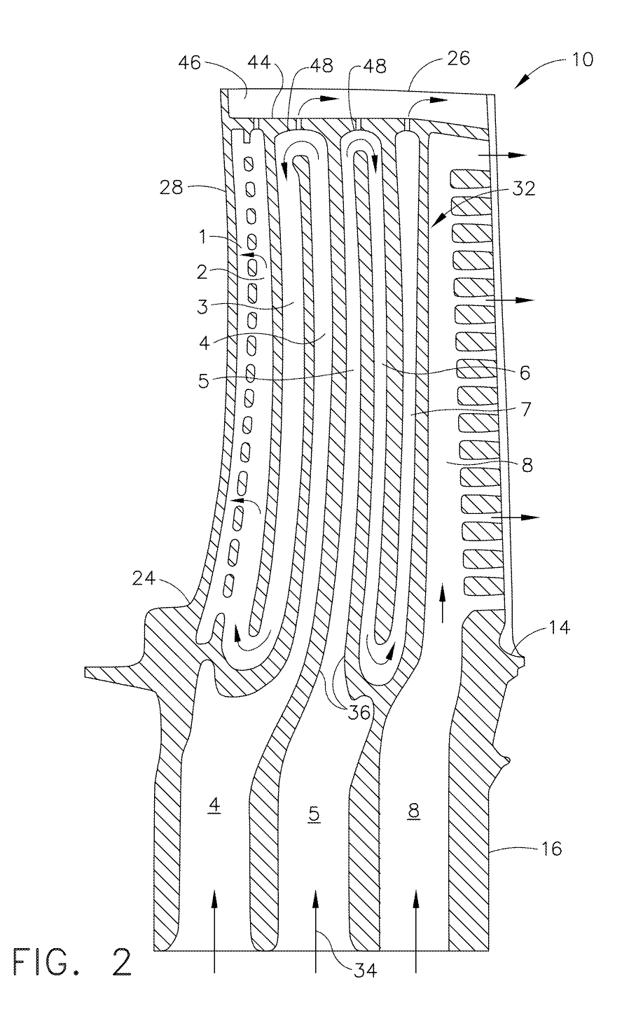

Referring to FIGS. 1 and 2, a prior art turbine blade 10, configured for use in the first stage of an HPT engine, includes an airfoil 12, platform 14, and dovetail 16 integrally joined together. The airfoil 12 is hollow and includes an internal cooling circuit 32 through which cooling airflow 34 is circulated during operation. The exemplary cooling circuit 32 has a plurality of radial flow cavities or passages 1-8 extending from the root 24 to the tip 26. For example, the fourth passage 4 extends inwardly through the dovetail 16 and platform 14 to form a series of looped passages traveling along the spanwise length of the airfoil 12. The fifth passage 5 similarly extends inwardly through the dovetail 16 and platform 14 to form another series of separate, looped passages traveling along the spanwise length of the airfoil 12.

The cooling circuit 32 may have any conventional configuration, and typically also includes various rows of film cooling holes 38 inclined through the pressure and suction sidewalls of the airfoil as illustrated in FIG. 1. The film cooling holes 38 and impingement holes are typically relatively small for controlling and metering discharge of the cooling air therethrough. The nominal diameters of these holes 38 may be about 15-25 mils (0.38-0.57 mm), for example. In this way, the distribution of the cooling air received through the radial flow cavities or passages 1-8 of the cooling circuit 32 may be precisely distributed through the airfoil 12.

Another conventional feature in the prior art airfoil 12 illustrated in FIGS. 1 and 2 is the relatively thin tip cap 44 that transversely bridges the opposite sidewalls 20,22 at the airfoil tip 26 to provide the outer boundary for the internal cooling circuit 32. The turbine blade 10 includes cooperating dust holes 48 disposed in fluid communication with a corresponding portion of the internal cooling circuit 32 (passages 4 and 5 in FIG. 2).

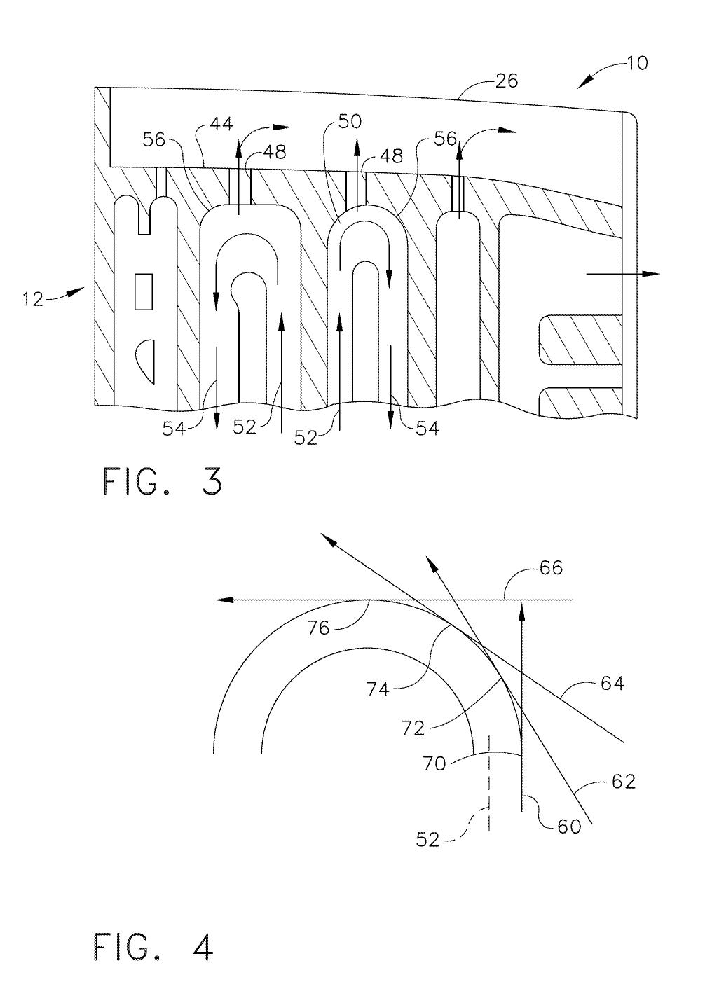

As shown in FIG. 3, the cooling circuit 32 includes a pair of U-shaped turns 50 that are operative to redirect airflow from a first mean radial direction entering the turn (represented by arrow 52) one hundred and eighty degrees to a second mean radial direction (represented by arrow 54). Obviously, the change from the first mean radial direction to the second mean radial direction does not occur instantaneously; rather, the curvature of the wall 56 delineating the cooling circuit at the turn 50 continues for a predetermined distance, representative of a semicircular pathway to change the mean radial direction.

Referring to FIG. 4, presuming the turn 50 includes an arcuate interior profile, the extent of the curvature may be represented by a series of tangent lines 60-66, for example. In this exemplary embodiment the first tangent line 60 is coaxial with the mean radial direction entering the turn (represented by dotted line 52) and representative of the starting point 70 of the curvature. Moving along the turn 50, a second tangent line 62 is representative of the curvature at a first downstream location 72. In this exemplary embodiment, the portion of the turn 50, which the second tangent line 62 is taken with respect to, is representative of the change in the mean radial direction of the internal wall (and airflow flowing therethrough) delineating the cooling circuit turn by thirty degrees, which has a mean radial direction of airflow flowing therethrough. This change in angle is confirmed by the second tangent line 62 being angled thirty degrees with respect to the first tangent line 60. Further downstream from the starting point 70 and first downstream location 72 is a second downstream location 74. This second downstream location 74 is curved and is representative of the change in mean radial direction of the internal wall (and airflow flowing therethrough) delineating the cooling circuit turn. More specifically, comparing the second downstream location 74 to the starting point 70, the curvature of the interior wall has changed by a total of sixty degrees, as has mean radial direction of airflow flowing therethrough. This change in angle is confirmed by the third tangent line 64 being angled sixty degrees with respect to the first tangent line 60. Finally, even further downstream from the second downstream location 74 is a third downstream location 76 midway along the length of the turn 50. This third downstream location 76 is curved and is representative of the change in mean radial direction of the internal wall delineating the cooling circuit turn. More specifically, comparing the third downstream location 76 to the starting point 70, the curvature of the interior wall has changed by a total of ninety degrees, as has mean radial direction of airflow flowing therethrough. This change in angle is confirmed by the fourth tangent line 66 being angled ninety degrees with respect to the first tangent line 60.

Referring back to FIG. 3, the dust discharge holes 48 each include a radial axis 50 extending therethrough that is representative of the mean radial direction of the walls delineating the dust discharge hole and the direction of airflow through the dust discharge hole. More specifically, this radial axis 50 is perpendicular with respect to the interior cooling circuit wall 56 as well as perpendicular with respect to the mean radial direction of airflow flowing past the cooling circuit wall.

It should also be noted that dust holes 48 are not readily confused with cooling holes 38. Each prior art dust hole 48 is relatively big and is typically about twice the flow diameter of the film cooling holes 38 illustrated in FIG. 1. For example, the dust hole 48 is typically a cylindrical or tubular hole from its inlet inside the airfoil to its outlet inside the tip well with a flow diameter of about 20-40 mils (0.5-1.0 mm).

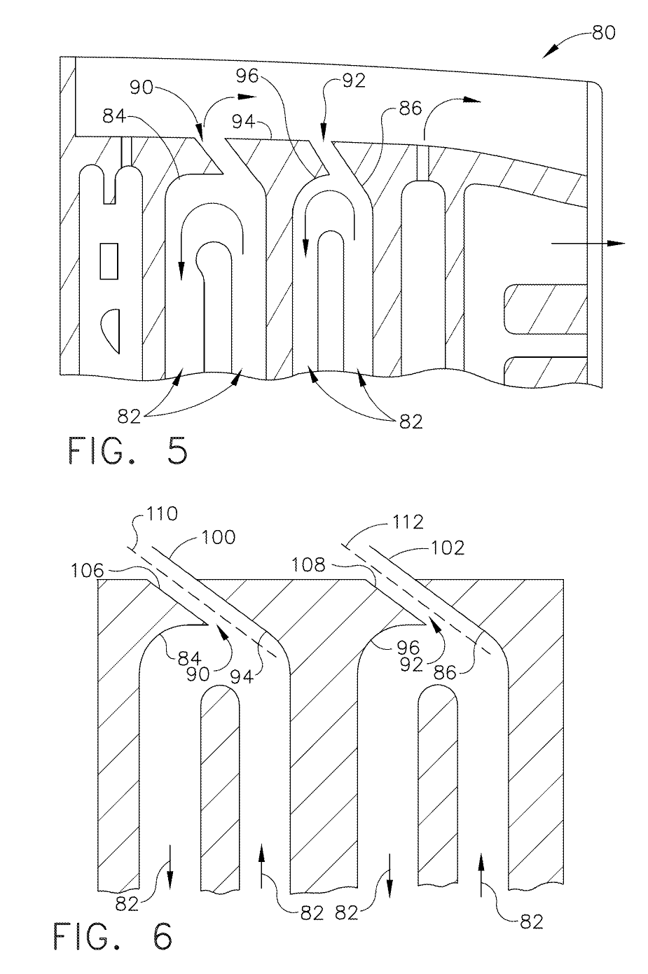

Turning to FIGS. 5 and 6, an improved cooling circuit 82 for the interior of a turbine blade 80 may include one or more turns 84, 86, in exemplary form depicted as separate U-shaped turns. For purposes of the instant disclosure, a “turn” refers to a section of the cooling circuit 82 operative to change the angle of the bulk median direction of airflow greater than or equal to thirty degrees. Unlike the prior art dust holes 48 previously referenced, this exemplary embodiment includes improved dust holes 90, 92 that are each angled to provide a proper transition from an interior cooling conduit wall 94, 96 delineating the turns 84, 86.

A first exemplary method and associated structure provides a proper transition between the interior cooling conduit wall 94, 96 and the dust hole 90, 92 by properly angling the dust hole with respect to the cooling circuit 82. By way of example, the location of a dust hole 90, 92 may be chosen to be ahead of, along, or downstream from the interior cooling conduit wall 94, 96 delineating the turn 84, 86. For purposes of explanation only, the dust hole 90, 92 will be formed along the interior cooling conduit wall 94, 96 delineating the turn 84, 86.

Once the location of the dust hole 90, 92 is selected, a tangent line 100, 102 is taken with respect to this point of curvature of the interior cooling conduit wall 94, 96. This tangent line 100, 102 may be utilized to define the trajectory of the dust hole 90, 92. More specifically, when using the tangent line 100, 102 to establish the trajectory of the dust hole 90, 92, the tangent line may establish a boundary for an interior wall 106, 108 of the dust hole. Depending upon the cross-sectional shape of the dust hole 90, 92, the tangent line 100, 102 may alternatively or in addition be used to establish a center line 110, 112 extending radially along the center of the dust hole. More specifically, in the case of a straight dust hole 90, 92, the tangent line 100, 102 may be coaxial with respect the established centerline 110, 112, whereas in the case of a non-linear dust hole 90, 92, the tangent line 100, 102 may be incrementally angled with respect to an established centerline. In this exemplary discussion, the dust holes 90, 92 are delineated by a straight cylindrical interior wall 106, 108 that has a substantially constant circular cross-section along the length of the centerline 110, 112, where the centerline is parallel to the tangent line 100, 102 and the straight cylindrical interior wall 106, 108 is coaxial with the tangent line.

The resulting interior wall 106, 108 of the dust hole 90, 92 is parallel or angled slightly with respect to the interior cooling conduit wall 94, 96 immediately preceding the dust hole. Consequently, the mean direction of airflow through the cooling circuit 82 at the location just preceding the dust hole 90, 92 is the same or minimally different from the mean direction of airflow through the dust hole. This zero or minimal directional change is helpful to direct particulates through the dust hole 90, 92 rather than continuing on along the cooling circuit 82.

By establishing a proper transition between the interior wall 94, 96 of the cooling circuit 82 and the interior wall 106, 108 of the dust hole 90, 92, regions of stagnant air may be inhibited or lessened. By lessening or eliminating stagnant air, the propensity of entrained particulates in the airflow becoming deposited on the interior walls 94, 96 is significantly reduced. By reducing the propensity of particulate deposition, heat transfer is increased by reducing the incidence of particulate layers interposing the airflow and interior walls 94, 96.

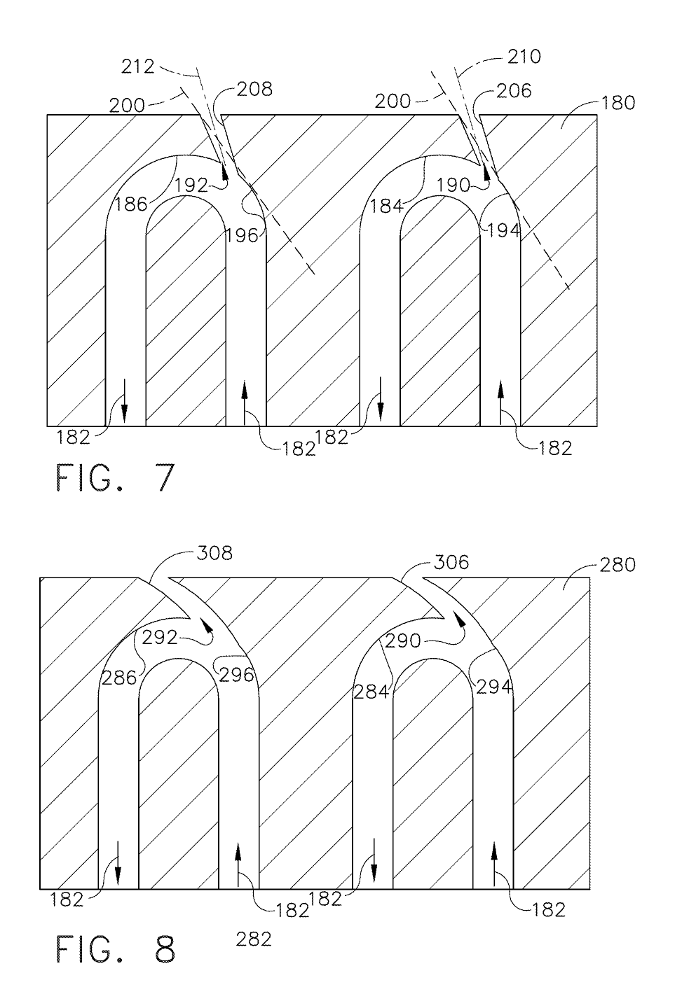

Referring to FIG. 7, a second improved cooling circuit 182 for the interior of a turbine blade 180 may include one or more turns 184, 186, in exemplary form depicted as separate U-shaped turns. For purposes of the instant disclosure, a “turn” refers to a section of the cooling circuit 182 operative to change the angle of the bulk median direction of airflow greater than or equal to thirty degrees. Unlike the prior art dust holes 48 previously referenced, this exemplary embodiment includes improved dust holes 190, 192 that are each angled to provide a proper transition from an interior cooling conduit wall 194, 196 delineating the turns 184, 186.

A second exemplary method and associated structure provides a proper transition between the interior cooling conduit wall 194, 196 and the dust hole 190, 192 by properly angling the dust hole with respect to the cooling circuit 182. By way of example, the location of a dust hole 190, 192 may be chosen to be ahead of, along, or downstream from the interior cooling conduit wall 194, 196 delineating the turn 184, 186. For purposes of explanation only, the dust hole 190, 192 will be formed along the interior cooling conduit wall 194, 196 delineating the turn 184, 186.

Once the location of the dust hole 190, 192 is selected, a tangent line 200, 202 is taken with respect to this point of curvature of the interior cooling conduit wall 194, 196. This tangent line 200, 202 may be utilized to orient the trajectory of the dust hole 190, 192. More specifically, when using the tangent line 200, 202 to orient the trajectory of the dust hole 190, 192, the tangent line may be used with an angular offset to establish a boundary for an interior wall 206, 208 of the dust hole. Depending upon the cross-sectional shape of the dust hole 190, 192, the tangent line 200, 202 may alternatively or in addition be used with an angular offset to establish a center line 210, 212 extending radially along the center of the dust hole. More specifically, in the case of a straight dust hole 190, the tangent line 200 may be angled with respect the interior wall 206 in the amount of the angular offset, whereas in the case of a tapering dust hole 192, the tangent line 202 may be incrementally angled with respect to an established centerline 212, also taking into account the angular offset. In this exemplary discussion, the first dust hole 190 is delineated by a straight and parallel cylindrical interior wall 206 having a constant circular cross-section along the length of the centerline 210, whereas the second dust hole 192 is delineated by a conical interior wall 208 having a progressively increasing circular cross-section along the length of the centerline 212.

The resulting interior wall 206, 208 of the dust hole 190, 192 is angled an offset amount (greater than zero and less than seventy degrees) with respect to the tangent line 200, 202 taken at the interior cooling conduit wall 194, 196 immediately preceding the dust hole. In this exemplary embodiment, the resulting interior wall 206 of the first dust hole 190 is angled fifteen degrees with respect to the tangent line 200 taken at the interior cooling conduit wall 194 immediately preceding the dust hole. Moreover, in further exemplary form, one portion of the resulting interior wall 208 of the dust hole 192 is angled fifteen degrees with respect to the tangent line 202, whereas a second portion opposite the first portion of the resulting interior wall 208 of the dust hole 192 is angled thirty degrees with respect to the tangent line 202. Consequently, the mean direction of airflow through the cooling circuit 182 at the location just preceding the dust hole 190, 192 is slightly different (i.e., between fifteen and thirty degrees different, in this exemplary embodiment) from the mean direction of airflow through the dust hole. This slight directional change is helpful to direct particulates through the dust holes 190, 192 rather than completing the turn 184, 186 and continuing on along the cooling circuit 182.

By establishing a proper transition between the interior wall 194, 196 of the cooling circuit 182 and the interior wall 206, 208 of the dust hole 190, 192, regions of stagnant air may be inhibited or lessened. By lessening or eliminating stagnant air, the propensity of entrained particulates in the airflow flowing through the cooling circuit 182 becoming deposited on the interior walls 194, 196 is significantly reduced. By reducing the propensity of particulate deposition, heat transfer is increased by reducing the incidence of particulate layers interposing the airflow and interior walls 194, 196.

Referring to FIG. 8, a third improved cooling circuit 282 for the interior of a turbine blade 280 may include one or more turns 284, 286, in exemplary form depicted as separate U-shaped turns. For purposes of the instant disclosure, a “turn” refers to a section of the cooling circuit 282 operative to change the angle of the bulk median direction of airflow greater than or equal to thirty degrees. Unlike the prior art dust holes 48 previously referenced, this exemplary embodiment includes improved dust holes 290, 292 that are each angled to provide a proper transition from an interior cooling conduit wall 294, 296 delineating the turns 284, 286.

A third exemplary method and associated structure provides a proper transition between the interior cooling conduit wall 294, 296 and the dust hole 290, 292 by properly angling the dust hole with respect to the cooling circuit 282. By way of example, the location of a dust hole 290, 292 may be chosen to be ahead of, along, or downstream from the interior cooling conduit wall 294, 296 delineating the turn 284, 286. For purposes of explanation only, the dust hole 290, 292 will be formed along the interior cooling conduit wall 294, 296 delineating the turn 284, 286.

Once the location of the dust hole 290, 292 is selected, a degree to curvature and length over which this curvature occurs is determined with respect to the interior cooling conduit wall 294, 296 delineating the turn 284, 286. This curvature calculation may be aided by using one or more tangent lines, or may be calculated or determined otherwise using the mean directional change of the airflow between an entry point to the turn 284, 286 and an exit point to the turn. Nevertheless, in the case of a dust hole 290, 292 having a curved interior wall 306, 308 along the direction of airflow, the length and curvature are determined so that the curvature over a unit length is different from that of the interior cooling conduit wall 294, 296 delineating the turn 284, 286.

In exemplary form, each dust hole 290, 292 follows a path having either a greater or lesser curvature per unit length than does the turn 284, 286, thereby creating a curved offshoot through which air and entrained particulates may be diverted from the bulk airflow through the interior cooling conduit wall 294, 296. In this exemplary embodiment, the curvature of each dust hole proximate the hole opening nearest the interior wall 194, 196 is approximately half of the curvature of the interior wall 194, 196 when taking into account overall curvature (i.e., from a starting location to a second location). In other words, the distance of the cooling circuit 282 along the turn 284, 286 is approximately half of the distance of the dust hole 290, 292 that would otherwise be necessary to accomplish the same directional flow change. Consequently, the mean direction of airflow through the cooling circuit 282 at the location just preceding the dust hole 290, 292 is insignificantly different than the mean direction of airflow entering the dust hole, even though the downstream mean direction of airflow through the dust hole is significantly different than the mean direction of airflow exiting the turns 284, 286. This inappreciable directional change at the beginning of the dust hole 290, 292 is helpful to funnel the heavier particulates through the dust hole 290, 292 rather than continuing on along the cooling circuit 282, but is ultimately large enough to establish two separate tracks for airflow to flow through that enters the cooling circuit 282.

By establishing a proper transition between the interior wall 294, 296 of the cooling circuit 282 and the interior wall 306, 308 of the dust hole 290, 292, regions of stagnant air may be inhibited or lessened. By lessening or eliminating stagnant air, the propensity of entrained particulates in the airflow becoming deposited on the interior walls 306, 308 is significantly reduced. By reducing the propensity of particulate deposition, heat transfer is increased by reducing the incidence of particulate layers interposing the airflow and interior walls 306, 308.

While the foregoing exemplary dust holes 90, 92, 190, 192, 290, 292 have been depicted graphically as a two-dimensional feature, it should be immediately apparent to those skilled in the art that the dust holes are in fact three dimensional features. Accordingly, while the holes have been shown in two dimensions in the figures, it should be understood that the three dimensional embodiment of the dust hole may have various shapes that range from circular, oblong, rectangular, or any number of various obvious alternatives in light of the foregoing disclosure. In addition, by way of example, the dust holes may include partial scoops or funnels operative to draw in additional fluid flow that would extend perpendicular to the views shown.

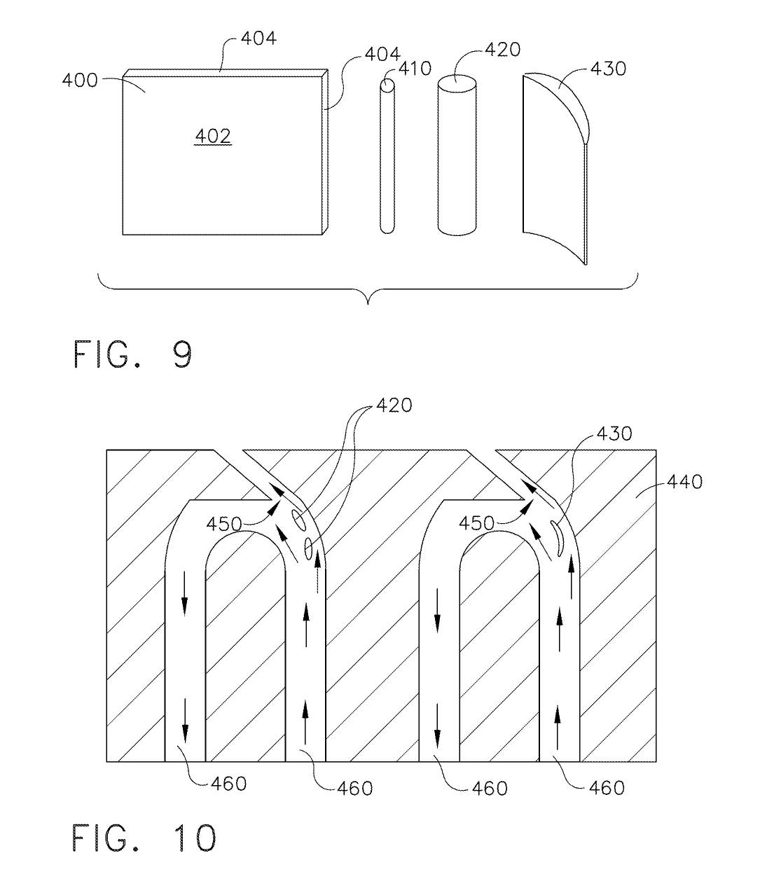

Referring to FIGS. 9 and 10, any or all of the foregoing improved cooling circuits 82, 182, 282 for the interior of a turbine blade may include one or more deflectors for directing particulates into the dust holes 90, 92, 190, 192, 290, 292. In exemplary form, the deflector extends into the primary cooling channel and works in tandem with the contours of the cooling channel interior wall preceding the dust hole to direct entrained particulates into and through the dust hole.

In exemplary form, a first exemplary deflector 400 comprises a projection that may extend directly from the interior cooling circuit wall or be spaced apart from the interior cooling circuit wall proximate the dust hole. This exemplary deflector 400 comprises a rectangular, planar front surface 402, a planar rear surface (not shown), and four rectangular, planar side surfaces 404, where the front surface establishes the length and height dimensions that are perpendicular to the widthwise dimension. It should be noted, however, that the deflector may be arcuate in any one or more of the three dimensions or take on other shapes. Moreover, in this exemplary deflector 400, the dominant dimensions of length and height far surpass the subservient dimension of width.

The exemplary deflector 400 may be angled at any number of various angles with respect to the interior wall(s) delineating the cooling circuit. In this exemplary embodiment, the deflector 400 extends in three perpendicular dimensions to provide a substantially constant width, a constant height, and a constant length. Those skilled in the art will understand that the height, width, and length may vary depending upon various factors including, without limitation, the dimension of the dust hole, the dimensions of the cooling conduit, the intended or maximum airflow rate through the cooling conduit, and the orientation of the deflector. In this exemplary circumstance, the deflector 400 has a height that may interpose and completely bridge opposing walls delineating the cooling conduit. The length of the deflector 400, on the other hand, may alternatively interpose opposing walls delineating the cooling conduit.

Those skilled in the art will understand that the shape of the deflector may be changed from the first exemplary deflector 400. As shown otherwise in FIG. 9, a series of exemplary deflectors are depicted. For example, a second exemplary deflector 410 has a substantially constant width, a linear height that may extend completely between opposing walls (e.g., ceiling and floor), and a convex length representative of a cylindrical projection having a circular cross-section. The dimensions of this deflector 410 may be varied, at least in part upon the dimensions of the cooling channel conduit, but in exemplary form the length/width of the deflector does not necessarily completely extend between opposing walls (e.g., left and right side walls). Moreover, a height of this deflector 410 may be varied and not necessarily completely extend between opposing walls (e.g., ceiling to floor). This deflector 410 may be positioned individually or as part of a series of deflectors oriented upstream from, within, and/or downstream from a turn of a cooling circuit in order to direct airflow and particulates in to one or more dust holes.

A third exemplary deflector 420, also has a cylindrical shape, with the cross-section being an oblong circle. Accordingly, the width and length of this exemplary deflector 420 are not the same, in contrast to the foregoing deflector 410. As with the second deflector 410, this third exemplary deflector 420 may have a length or width that need not necessarily completely extend between opposing walls (e.g., left and right side walls). Moreover, a height of this deflector 420 may be varied and not necessarily completely extend between opposing walls (e.g., ceiling to floor). This deflector 420 may be positioned individually or as part of a series of deflectors oriented upstream from, within, and/or downstream from a turn of a cooling circuit in order to direct airflow and particulates in to one or more dust holes.

The forth exemplary deflector 430 is simply aero deflector with curvature that gradually increases as the distance between the deflector and the dust hole decreases. More specifically, this deflector embodies a J-shaped cross-section with a planar top surface and perpendicular side surfaces.

Instead of having opposing planar surfaces, any of the foregoing deflectors 400, 410, 420, 430 may have planar surfaces that are not parallel. For example, the deflectors may incorporate “fastbacks” that taper the side surface to provide an angled or sloped surface instead of a blunt face that would otherwise extend generally perpendicular with respect to the interior wall delineating the cooling circuit. While the deflectors each operates to direct airflow into a dust hole, the fastback operates to decrease the presence of stagnate airflow downstream from the deflector, thereby increasing heat transfer and retarding the incidence of particulate deposition at the rear of the deflector.

As shown in FIG. 10, the exemplary defectors may be utilized within a HPT blade 440 individually or in combination with one another proximate the dust holes 90, 92, 190, 192, 290, 292 (labeled collectively using reference numeral 450) in order to direct airflow therein while cooling airflow is flowing through a cooling circuit 460. In exemplary form the deflectors may be positioned upstream from the dust holes 450. Those skilled in the art will understand the various combinations that are readily apparent by using one or more of the exemplary deflectors and obvious variations of these deflectors.

Finally, it is also within the scope of the disclosure to increase the cross-section of the dust hole 450 mouth. One exemplary approach is to round over the edges between the walls delineating the dust holes 450 and the internal cooling circuit wall(s). By rounding over the edges, the airflow into the dust holes 450 may be increased and become more predictable so that the heavier entrained particulates are more readily drawn through the dust holes.

While the foregoing exemplary methods and structures have been described as being applicable to the cooling circuit of a turbine blade, it should be noted that these methods and structures are applicable to other structures within a turbine engine such as, without limitation, turbine engine combustor liners, stationary (i.e., frame) structures, turbine shrouds and hangers, turbine disks and seals, and the interiors of stationary or rotating engine airfoils such as nozzles. The foregoing methods and structures are exemplary of solutions for reducing or eliminating particulate deposition within turns in a cooling conduit and may be incorporated into the casting of a component, may be machined into a component, or may be provided as separate structures that are then attached to the component.

Following from the foregoing description, which is provided for the purpose of illustration only and not for the purpose of limitation, it should be apparent to those of ordinary skill in the art that, while the methods and apparatuses herein described constitute exemplary embodiments of the present disclosure, the disclosure is not necessarily limited to the precise embodiments and changes may be made to such embodiments without departing from the scope of the disclosure. Additionally, it is to be understood that it is not intended that any limitations or elements describing the exemplary embodiments set forth herein are to be incorporated into the interpretation of what constitutes the disclosure unless such feature or element is explicitly stated as necessary to comprise the disclosure. Likewise, it is to be understood that it is not necessary to meet any or all of the identified advantages or objects of the foregoing exemplary embodiments in order to fall within the scope of the disclosure since inherent and/or unforeseen advantages of the present disclosure may exist even though they may not have been explicitly discussed herein.

What is claimed is:

1. A turbine engine device comprising:
a turbine engine blade including a cooling channel extending on the interior of the blade, the cooling channel having at least one turn of greater than forty-five degrees, the cooling channel turn demarcated by a cooling channel wall having a curvature operative to redirect fluid flowing therein, the cooling channel wall including a dust opening leading into a dust hole demarcated by a dust wall having a longitudinal axis that is coaxial with a tangent line taken along the curvature of the cooling channel wall.

2. The turbine engine device of claim 1, wherein the at least one turn is ninety degrees or greater.

3. The turbine engine device of claim 1, wherein the at least one turn is more than one hundred twenty degrees.

4. The turbine engine device of claim 1, wherein the cooling channel wall defining the at least one turn has an arcuate profile.

5. The turbine engine device of claim 1, wherein the cooling channel wall defining the at least one turn comprises a plurality of planar surfaces in series that are each angled less than forty-five degrees with respect to an adjoining planar surface of the plurality of planar surfaces.

6. The turbine engine device of claim 1, further comprising a projection having a deflecting surface spaced from the cooling channel wall and configured to direct at least a portion of the fluid through the dust hole, where an angle of the deflecting surface is less than forty degrees different from the longitudinal axis of the dust wall.

7. The turbine engine device of claim 1, wherein the dust opening is positioned at least one of just prior to, within, and immediately following the at least one turn.

8. A turbine engine device comprising:
a turbine engine blade including a cooling channel extending on the interior of the blade, the cooling channel having at least one turn of greater than forty-five degrees, the cooling channel turn demarcated by a cooling channel wall having a curvature operative to redirect fluid flowing therein, the cooling channel wall including a dust hole demarcated by a dust hole wall having a hole curvature that extends the curvature of the cooling channel wall

9. The turbine engine device of claim 8, wherein the at least one turn is ninety degrees or greater.

10. The turbine engine device of claim 8, wherein the at least one turn is more than one hundred twenty degrees.

11. The turbine engine device of claim 8, wherein the cooling channel wall defining the at least one turn has an arcuate profile.

12. The turbine engine device of claim 8, wherein the cooling channel wall defining the at least one turn comprises a plurality of planar surfaces in series that are each angled less than forty-five degrees with respect to an adjoining planar surface of the plurality of planar surfaces.

13. The turbine engine device of claim 8, further comprising a projection having a deflecting surface spaced from the cooling channel wall and configured to direct at least a portion of the fluid through the dust hole, where an angle of the deflecting surface is less than forty degrees different from a longitudinal axis of the dust conduit wall.

14. The turbine engine device of claim 8, wherein the dust hole is positioned at least one of just prior to, within, and immediately following the at least one turn.

15. A turbine engine device comprising:
a turbine engine blade including a cooling channel extending on the interior of the blade, the cooling channel having at least one turn configured to change a mean radial direction of fluid flowing therein by greater than forty-five degrees, the cooling channel turn demarcated by a cooling channel wall configured to change the mean radial direction of fluid flowing therein, the cooling channel wall including a dust passage oriented less than thirty degrees offset from the surrounding cooling channel wall, the cooling channel wall also including a deflector extending into the cooling channel upstream from the dust passage.

16. The turbine engine device of claim 15, wherein the at least one turn is ninety degrees or greater.

17. The turbine engine device of claim 15, wherein the at least one turn is more than one hundred twenty degrees.

18. The turbine engine device of claim 15, wherein the cooling channel wall defining the at least one turn has an arcuate profile.

19. The turbine engine device of claim 15, wherein the cooling channel wall defining the at least one turn comprises a plurality of planar surfaces in series that are each angled less than forty-five degrees with respect to an adjoining planar surface of the plurality of planar surfaces.

20. The turbine engine device of claim 15, further comprising a projection having a deflecting surface spaced from the cooling channel wall and configured to direct at least a portion of the fluid through the dust passage, where an angle of the deflecting surface is less than twenty degrees different from an angle of the dust passage wall.

21. The turbine engine device of claim 15, wherein the dust passage is oriented less than fifteen degrees offset from the surrounding cooling channel wall.

22. A turbine engine device comprising:
a turbine engine blade including a cooling channel extending on the interior of the blade, the cooling channel having at least one turn of greater than forty-five degrees, the cooling channel turn demarcated by a cooling channel wall having a shape operative to redirect fluid flowing therein, the cooling channel wall including a dust hole within the cooling channel turn, the dust hole demarcated by a dust wall angled less than thirty degrees with respect to the cooling channel wall bordering the dust hole.

23. The turbine engine device of claim 22, wherein the at least one turn is ninety degrees or greater.

24. The turbine engine device of claim 22, wherein the at least one turn is more than one hundred twenty degrees.

25. The turbine engine device of claim 22, wherein the cooling channel wall defining the at least one turn has an arcuate profile.

26. The turbine engine device of claim 22, wherein the cooling channel wall defining the at least one turn comprises a plurality of planar surfaces in series that are each angled less than forty-five degrees with respect to an adjoining planar surface of the plurality of planar surfaces.

27. The turbine engine device of claim 22, further comprising a projection having a deflecting surface spaced from the cooling channel wall and configured to direct at least a portion of the fluid through the dust hole, where an angle of the deflecting surface is less than twenty degrees different from an angle of a dust conduit downstream from the dust hole.

28. A turbine engine device comprising:
a turbine engine blade including a cooling channel extending on the interior of the blade, the cooling channel demarcated by a cooling channel wall establishing a mean radial direction of fluid flowing therein, the cooling channel also including a projection having a deflecting surface extending into the cooling channel and configured to change the mean radial direction of the fluid flowing therepast, the cooling channel wall including a dust hole proximate the projection, where the deflecting surface is configured to direct at least a portion of the fluid into the dust hole.

29. The turbine engine device of claim 28, wherein the cooling channel wall demarcates at least one turn of greater than forty-five degrees.

30. The turbine engine device of claim 29, wherein the at least one turn is ninety degrees or greater.

31. The turbine engine device of claim 29, wherein the at least one turn is more than one hundred twenty degrees.

32. The turbine engine device of claim 29, wherein:
the cooling channel wall defining the at least one turn has an arcuate profile; and,
where an angle of the deflecting surface is less than twenty degrees different from an angle of a wall of the dust conduit.

33. The turbine engine device of claim 29, wherein the cooling channel wall defining the at least one turn comprises a plurality of planar surfaces in series that are each angled less than forty-five degrees with respect to an adjoining planar surface of the plurality of planar surfaces.

34. The turbine engine device of claim 29, wherein the projection is positioned at least one of just prior to, within, and immediately following the at least one turn.

35. The turbine engine device of claim 29, wherein the projection includes a fastback.

36. A turbine engine device comprising:
a turbine engine blade including a cooling channel extending on the interior of the blade, the cooling channel having at least one turn of greater than forty-five degrees and operative to redirect fluid flowing therein, the cooling channel wall including a dust hole positioned at least one of just prior to, within, and immediately following the turn, where a mean radial direction of the dust hole is angled no more than forty-five degrees with respect to a mean radial direction of the cooling channel wall prior to reaching the dust hole.

37. The turbine engine device of claim 36, wherein the at least one turn is ninety degrees or greater.

38. The turbine engine device of claim 36, wherein the at least one turn is more than one hundred twenty degrees.

39. The turbine engine device of claim 36, wherein the cooling channel wall defining the at least one turn has an arcuate profile.

40. The turbine engine device of claim 36, wherein the cooling channel wall defining the at least one turn comprises a plurality of planar surfaces in series that are each angled less than forty-five degrees with respect to an adjoining planar surface of the plurality of planar surfaces.

41. The turbine engine device of claim 36, further comprising a projection having a deflecting surface spaced from the cooling channel wall and configured to direct at least a portion of the fluid through the dust hole, where an angle of the deflecting surface is less than forty degrees different from a radial axis extending along a dust conduit wall, which extends from the dust hole.
